(19) United States
(12) Patent Application Publication
(10) Pub. No.: US 2012/0139676 A1
(43) Pub. Date: Jun. 7, 2012

(54) MAGNETIC FIELD GENERATOR AND MAGNETOCALORIC DEVICE COMPRISING SAID MAGNETIC FIELD GENERATOR

(75) Inventors: Osmann Sari, Yverdon-les-Bains (CH); Nathanael Alber, La Cote-aux-Fees (CH)

(73) Assignee: HAUTE ECOLE D'INGENIERIE ET DE GESTION DU CANTON DE VAUD (HEIG-VD), Yverdon-les-Bains (CH)

(21) Appl. No.: 13/375,555

(22) PCT Filed: Jun. 1, 2010
(86) PCT No.: PCT/CH10/00143

§ 371 Date: Feb. 21, 2012

(30) Foreign Application Priority Data
Jun. 2, 2009 (CH) 837/09

(51) Int. Cl. H01F 7/02

(52) U.S. Cl. 335/219; 335/306

(57) ABSTRACT

A magnetic field generator (10) comprising an assembly (20) of permanent magnets (30) inside which the magnetic flux concentrates. The assembly comprises opposed first and second elements (21, 22) that include magnets (30). The elements (21) and (22) are arranged substantially in the same plane and surrounded by respective closing mechanisms (51, 52). The permanent magnets (30) are made up of parallelepipedal blocks, arranged substantially in an arc of a circle according to three areas: a central area (60), a first side area (70) on one side of the central area (60), and a second side area (80) on the other side of the central area (60). The permanent magnets (30) of the first and second (70, 80) side areas have opposite directions of magnetization. Two parts (91) and (92) of a ferromagnetic material, forming a magnetic flux concentrator (90), are arranged on either side of the air gap (40).

This application is a National Stage Completion of PCT/CH2010/000143 filed Jun. 1, 2010 which claims priority from Swiss Application Serial No. 837/09 filed Jun. 2, 2009.

### FIELD OF THE INVENTION

The present invention concerns a magnetic field generator comprising at least one assembly of anisotropic permanent magnets for creating a magnetic field and defining an air gap within which the magnetic flux is concentrated,

said assembly comprising a first element and a second element mounted across from each other and symmetrically relative to an axis perpendicular to the transverse axis of the air gap;

each of said first and second elements comprising at least three permanent magnets, and

said first and said second elements of said assembly of magnets being disposed generally in the same plane and at least partially surrounded, respectively, by mechanisms for closing the magnetic field.

A further objective is a thermal magnetocaloric device comprising at least one magnetic field generator according to the invention and one magnetocaloric element traversed by a heat transporting fluid circulating alternately towards a first extremity of said thermal generator and towards its second extremity, as well as a means for magnetically activating and deactivating the displacement of the magnetocaloric element relative to said magnetic field generator.

### BACKGROUND OF THE INVENTION

In order to obtain a strong magnetic field in a defined area, the technique of forming an assembly of permanent magnets already exists. The literature describes such assemblies, in particular for magnetic resonance imaging applications in the medical domain. In this domain, rings of permanent magnets are formed and arranged side by side. The structure of the utilized permanent magnets, however, is difficult to achieve, which increases the cost of magnet assemblies.

For this reason, it is not possible to transpose such magnetic structures, particularly in the domain of magnetocaloric thermal generators. Actually, with these generators, it is imperative to generate a uniform, intense and variable magnetic field in an air gap essentially corresponding to the volume of a material or a magnetocaloric element so that the magnetic field created can successively magnetically activate and deactivate one or more magnetocaloric materials alternately introduced and then withdrawn from the air gap.

In order to create a strong magnetic field in a defined space, a method exists for forming an assembly of permanent magnets according to a Halbarch structure. The literature, particularly the following publications: J. Lee, J. M. Kenkel and D. C. Jiles, “Design of Permanent-Magnet Field Source for Rotary-Magnetic Refrigeration Systems,” IEEE Trans Magn 38 5 (2002), pp. 2991-2993; K. Halbach, “Nucl. Instr. Methods,” Vol. 169, p. 1 (1981); F. Bloch, O. Gugat, J.C. Toussaint and G. Meunier, IEEE Trans. Magn., Vol. 34, p. 2465 (1998); “CERN Courier”, Vol. 43, No. 3, p. 7 (2002); and S.J. Lee and D.C. Jiles, IEEE Trans. Magn., Vol. 36, No. 5, p. 3105 (2000) describes such assemblies, particularly for an application in the medical domain of magnetic resonance imaging.

### SUMMARY OF THE INVENTION

The present invention attempts to overcome the drawbacks of the prior art by proposing a device for generating an intense and uniform magnetic field that is easy to achieve and low cost.

To achieve this, the invention concerns a magnetic field generator such as the one described in the preamble, characterized in that said permanent magnets on said first and second elements of said magnet assemblies consist of parallelepipedal shaped blocks, in that they are arranged in a generally circular arc in three zones, a central zone located opposite said air gap, a first lateral zone located beside said central zone, and a second lateral zone located on the other side of said central zone, with said permanent magnets of said first and second lateral zones magnetizing in the direction opposite to the perpendicular transverse axis of said air gap, and in that at least two pieces of ferromagnetic material, constituting a magnetic flux concentrator, are disposed on either side of said air gap, respectively, between the permanent magnets of said first lateral zones of the first and second elements of the magnetic assembly, located on one side of said central zones and between the permanent magnets of said second lateral zones of the first and second elements of the assembly of magnets, located on the other side of said central zones.

Preferably the permanent magnets may consist of blocks with a parallelepipedal shape and with a rectangular and/or trapezoidal transverse cross-section.

According to a preferred embodiment, the generator comprises several groups of permanent anisotropic magnet assemblies, with said magnet assemblies being identical and the group comprising a single air gap, each group of magnet assemblies creating a magnetic flux and comprising a means for concentrating the magnetic flux generated by said group of magnet assemblies inside said single air gap.

Advantageously, the generator may comprise several groups of permanent anisotropic magnet assemblies, said magnet assemblies being different, juxtaposed and arranged to form a single air gap, each group of magnet assemblies creating a magnetic flux and comprising a means of concentrating the magnetic flux generated by said group of magnet assemblies inside said single air gap.

According to a particularly advantageous embodiment, each of the mechanisms for closing the magnetic field on said first and second elements of said magnet assembly has an essentially circular arc interior profile corresponding to the circular arc arrangement of the three permanent magnet zones in said first and second elements of said magnet assembly.

Preferably, said permanent magnets are arranged in said magnet assembly in such a way that

in said central zone they are magnetized approximately tangentially to the adjacent surface of the mechanism for closing the corresponding magnetic field; and

in said first and second lateral zones, they are magnetized is perpendicularly to the corresponding surface of the mechanism for closing the corresponding magnetic field.

In a particularly advantageous manner, in said first and second lateral zones, the permanent magnets are magnetized perpendicularly to the adjacent surface of the two pieces of the corresponding magnetic flux concentrator.

The permanent magnets in the two lateral zones may each be mounted on one of the pieces of the corresponding magnetic flux concentrator.

The pieces of said magnetic flux concentrator may have oblique surfaces on one side corresponding in shape to the surface of the corresponding permanent magnets in the two lateral zones and on the other side, a projecting portion at the level of the air gap.

According to one particular design, each first and each second element of said magnet assembly is respectively associated with one first and one second mechanism for closing the magnetic field.

According to another particular design, each first and each second element of said magnet assembly is respectively associated with several first and several second mechanisms for closing the magnetic field.

The invention also concerns a thermal magnetocaloric device such as the one defined in the preamble and characterized in that said magnetic field generator constitutes the means for magnetically activating and deactivating the magnetocaloric element, and in that said magnetocaloric element is located in the air gap of said magnetic field generator.

### BRIEF DESCRIPTION OF THE DRAWINGS

The present invention and its features will be more apparent from the following description of embodiments provided by way of non-limiting examples, with reference to the attached drawings, in which:

FIG. 1 is a perspective view of a first embodiment of a magnetic field generator according to the invention;

FIG. 2 is a perspective view of a second embodiment of a magnetic field generator according to the invention;

FIG. 3 is an elevation illustrating the arrangement of the magnets in the embodiment of FIG. 1;

FIG. 4 is a schematic plane view representing the distribution of the field lines in the embodiment of FIG. 1;

FIG. 5 is a partial cross-section of the magnetic field generator shown in FIG. 2;

FIG. 6 is a partial cross-section of a variation of the embodiment of the magnetic field generator shown in FIG. 2; and

FIGS. 7A through 7C are complete and partial perspectives, respectively, and an elevation, of a third embodiment of the magnetic field generator according to the invention.

### DETAILED DESCRIPTION OF THE INVENTION

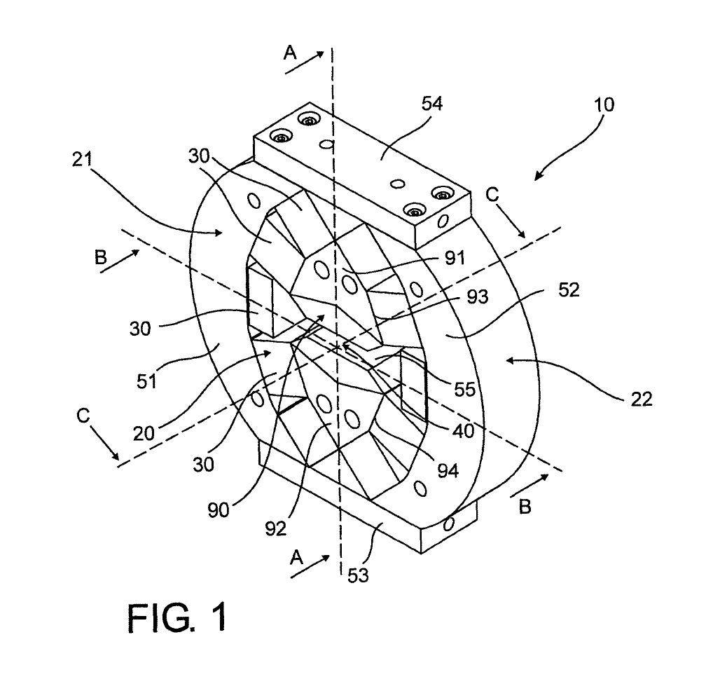

FIG. 1 represents an elementary embodiment of a magnetic field generator 10 according to the invention. This magnetic field generator 10, in this case, is composed of an assembly 20 of permanent anisotropic magnets 30 which create a magnetic flux and define an air gap 40 inside which the magnetic flux is concentrated. The assembly 20 of magnets consists of two elements 21 and 22 mounted across from each other symmetrically in relation to an axis A-A, and perpendicular to a transverse axis B-B of the air gap 40. Elements 21 and 22 are identical and arranged facing each other. In the shown example, they each comprise five permanent magnets 30, a number that may vary depending upon the embodiment desired, arranged in two opposing circular arcs. In this case, these permanent magnets are essentially rectangular in cross-section, such that a generally triangular space exists between two adjacent magnets. These permanent magnets 30, which form the two elements 21 and 22 of assembly 20, are separated by a magnetic flux concentrator 90 consisting of two elements 91 and 92 made of ferromagnetic material. These elements 91 and 92 may be made of ferromagnetic steel, for example, and may have oblique surfaces 93 and 94 corresponding in shape to an adjacent surface of permanent magnets 30, with these surfaces being in contact with said ferromagnetic elements 91 and 92. A closed magnetic flux loop results, thanks to two mechanisms 51 and 52 for closing the magnetic field, made of ferromagnetic material, surrounding permanent magnets 30 and attached to the latter through magnetic attraction. The two closing mechanisms 51 and 52 are held in place by two transverse clamps screwed in place. Closing mechanisms 51 and 52 may also have a layered structure to increase their effectiveness.

The configuration of the magnetic field generator 10, shown in FIG. 1, permits the use of permanent magnets 30 with an easy to achieve shape. For this reason, the geometric shape of said permanent magnets 30 is a parallelopipedal block and they are anisotropically magnetized. The parallelopipedal blocks have a square cross-section, but could also be configured with a rectangular cross-section. Likewise, the parallelopipedal blocks could be cubical in shape.

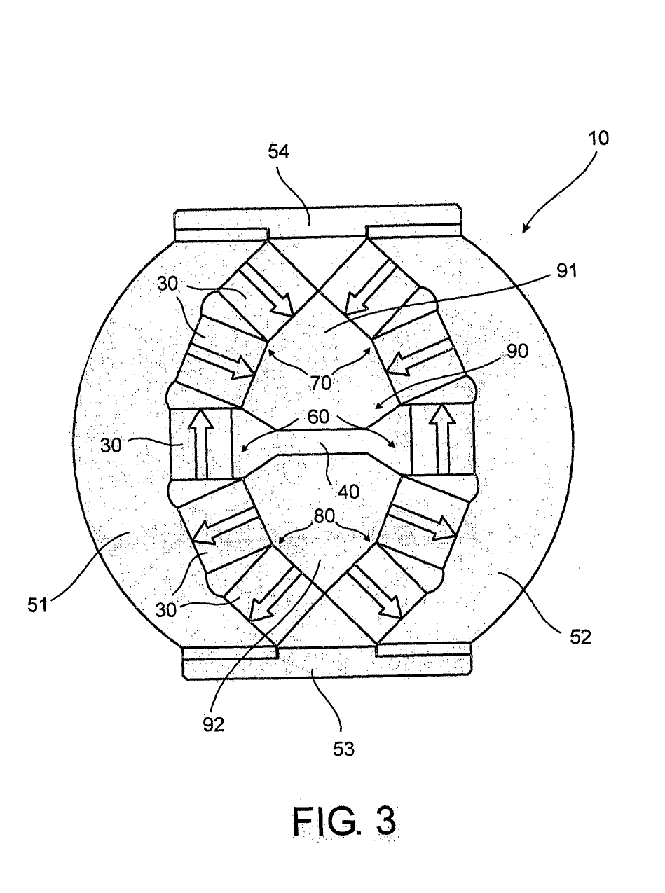

As FIG. 3 shows in particular, permanent magnets 30 of assembly 20 are arranged at the level of each of the circular arcs they form in three zones, specifically, a central zone 60 located opposite said air gap 40 and which comprises, in the example shown, a single permanent magnet 30 that is magnetized tangentially to the closing mechanism 51 or 52 for the corresponding magnetic field, and two other zones called adjacent zones 70 and 80 that have magnets mounted on magnetic flux concentrator 90, more specifically, on oblique surfaces 93, 94 of ferromagnetic pieces 91 and 92 constituting it. The permanent magnets 30 in the adjacent zones number two for each of said zones, 70 and 80, respectively, for each element 21 and 22 of assembly 20. Note that said zones adjacent to central zone 60, called the first lateral zone 70 and the second lateral zone 80, located on either side of central zones 60, are magnetized in opposite directions. These directions are perpendicular to both said concentrator 90 and to ferromagnetic elements 91 and 92 constituting it, as well as to mechanisms 51 and 52 for closing the magnetic field.

The space between the two pieces 91 and 92, forming magnetic flux concentrator 90, constitutes the air gap 40 of the magnetic field generator 10 shown. To further improve a magnetic flux density in this gap 40, these two pieces 91 and 92 each comprise a projecting portion 55 extending into said gap 40.

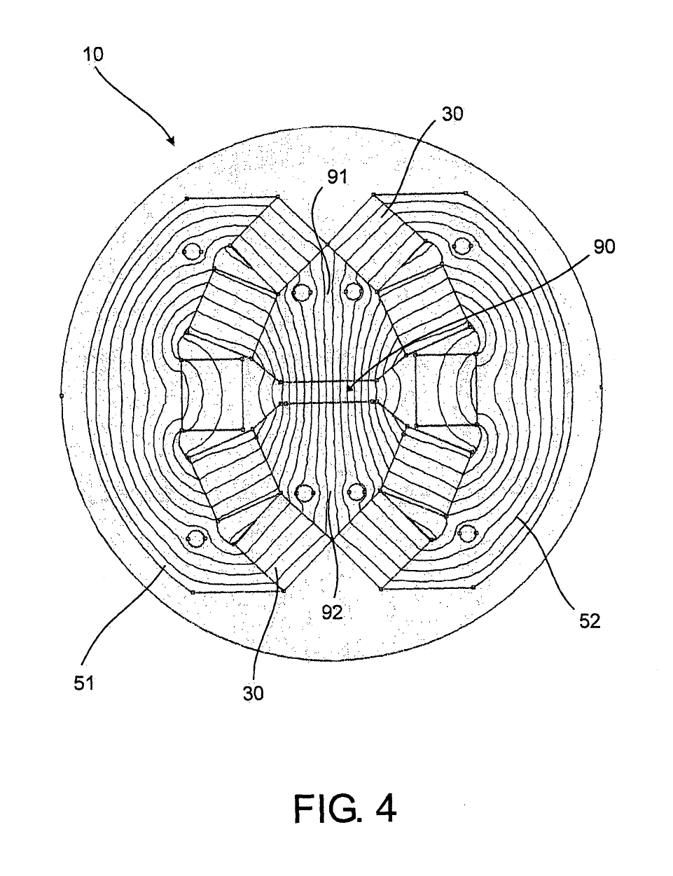

FIG. 4 shows the magnetic flux lines in magnetic field generator 10 of FIG. 1. Note that the flux lines are concentrated at the level of gap 40. Arched magnetic field closing mechanisms 51 and 52 and the two pieces 91 and 92 of magnetic flux concentrator 90 made of ferromagnetic material allow the formation of regular magnetic flux loops concentrated uniquely in the space of magnetic field generator 10, which are dominant and uniformly distributed throughout gap 40. This results in a generator 10 capable of generating an intense field in its gap 40, despite using a reduced number of permanent magnets, giving it an advantageously simple, economical structure.

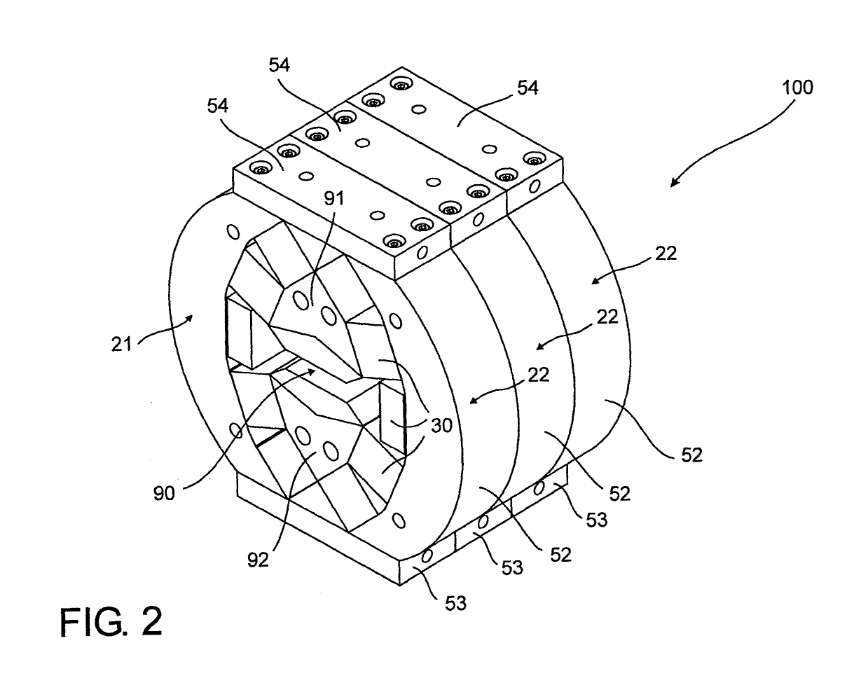

Magnetic field generator 100 shown in FIG. 2 is composed of a unit of assemblies 20 of identical juxtaposed magnets. In the example shown, the number of these magnet assemblies 20 is three, but it could either be limited to two or increased depending upon the parameters desired for a specific given application. Since the lateral dimension of each magnet assembly 20 is defined by the width of mechanisms 51 and 52 for closing the magnetic field, the magnet assemblies are placed against each other and held in position by a suitable mechanical attachment (not shown).

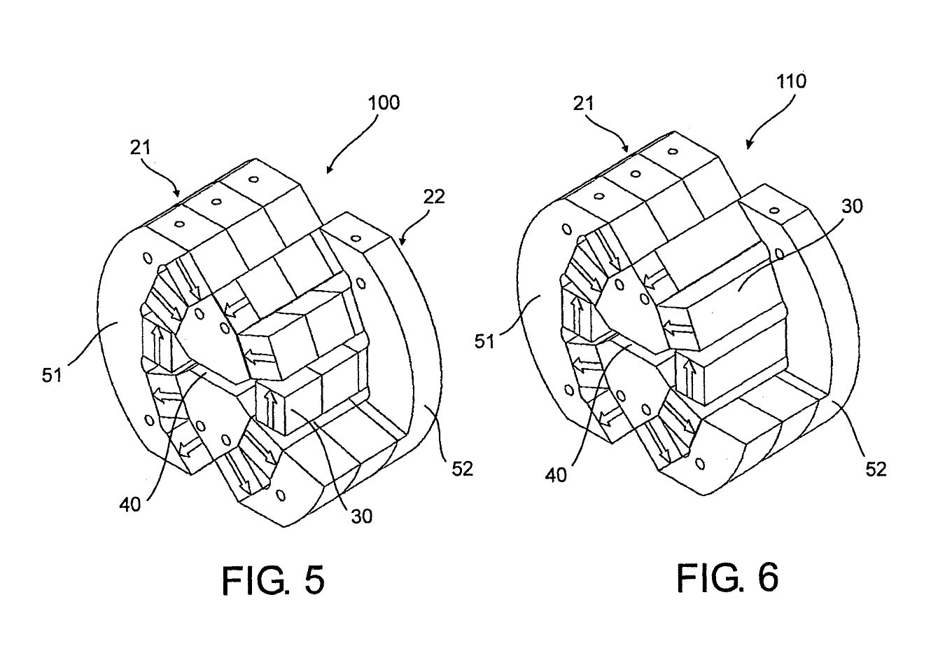

In the embodiments shown in FIGS. 1 and 2, a closing mechanism 51, 52 is associated with each first and second element 21, 22, respectively. This construction is more apparent in FIG. 5, which shows magnetic field generator 100 of FIG. 2 in partial cross-section.

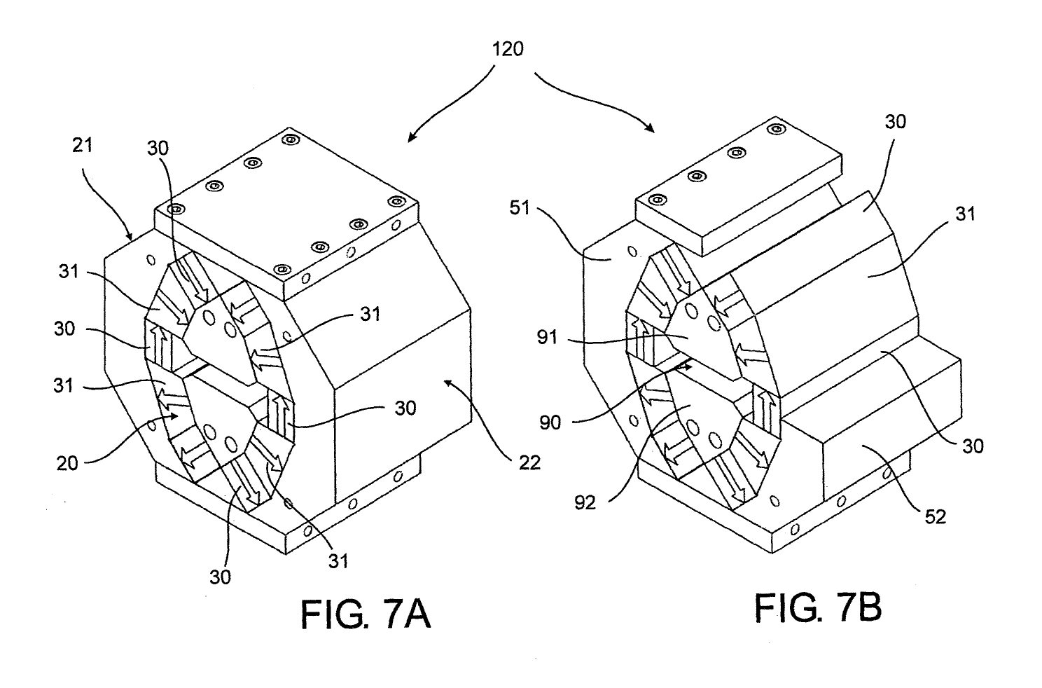

It is also possible to associate several closing mechanisms 51, 52 with each first or second element 21, 22. In such a configuration, shown by magnetic field generator 110 in FIG. 6, the length of permanent magnets 30 (along longitudinal axis C-C of air gap 40) is greater than the width of each closing mechanism 51, 52 taken independently. The advantage of this type of configuration resides in its ease of assembly. It could also be expected that for a given generator length, this configuration allows a stronger magnetic field to be obtained in air gap 40. In magnetic field generator 110 shown in FIG. 6, the length of a permanent magnet 30 corresponds to the width of three closing mechanisms 51, 52 arranged side by side. However, this number is not limitative and it may vary depending on the design or on the applications at hand.

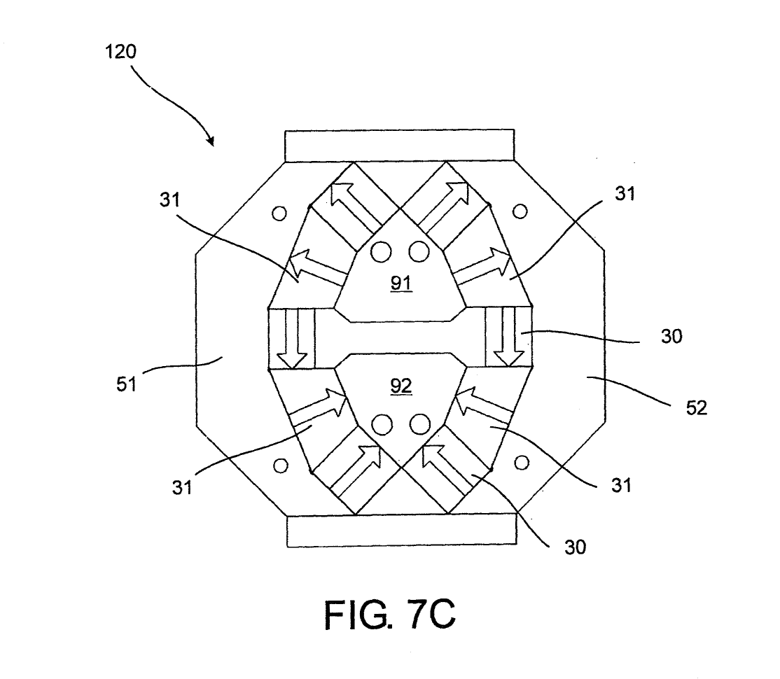

A third embodiment of a magnetic field generator according to the invention is shown in FIGS. 7A through 7C. As with magnetic field generator 10 in FIG. 1, magnetic field generator 120 comprises an assembly 20 of permanent magnets 30, said magnet assembly being composed of two identical elements 21, 22 arranged opposite each other. It is noteworthy that in the designs described previously, permanent magnets 30 are shaped like blocks with a rectangular cross-section. Given that they are arranged in two opposing circular arcs, the geometry of their rectangular cross-section creates a generally triangular corner between two adjacent permanent magnets 30. This space, filled with air, does not optimally conduct the field lines, causing loss of magnetism and, to some extent, reducing the strength of the magnetic field generated. This embodiment, illustrated by FIGS. 7A through 7C, solves that problem by filling in the space between two blocks of adjacent permanent magnets. It is for this reason that at least one permanent magnet 31, located between two adjacent permanent magnets 30 with rectangular cross-sections, has a trapezoidal cross-section that eliminates all the “openings” in the magnetic circuit and creates a sort of uninterrupted magnetic ring around elements 91 and 92 of magnetic flux concentrator 90. Additionally, the geometry of mechanisms 51 and 52, for closing the magnetic field in this embodiment, differs from the geometry of the embodiments shown in FIGS. 1 through 6 in that it is semi-hexagonal in shape and not semi-cylindrical.

Magnetic field generators 10, 100, 110 and 120 illustrated by all the drawings are particularly useful in a thermal magnetocaloric device comprising at least one magnetocaloric element. This magnetocaloric element may consist of one or more magnetocaloric materials and it is traversed by a heat-transporting fluid circulating alternately towards the first extremity of said thermal generator and then towards its second extremity, in a synchronized manner and with a means for magnetically activating and deactivating said magnetocaloric element. The purpose of this magnetic activation and deactivation means is to successively and alternately subject said magnetocaloric element to a magnetic field and then to a null field; this is achieved by the movement of magnetic field generator 10, 100, 110, 120 of the invention relative to said magnetocaloric element in order to achieve the variation in the magnetic field. Preferably, the magnetocaloric element that slides within the air gap of said magnetic field generator is driven in forward and backward translational movement.

Possibilities for Industrial Application

It is clear from this description that the invention achieves the stated goals, that is, providing a generator to create a magnetic field that is structurally simple, economical, and furnishes a strong magnetic field using relatively little magnetized material. Such a generator assuredly has industrial as well as domestic applications when integrated into a magnetocaloric thermal device designed for heating, air conditioning, temperature modulation, cooling or the like. It is competitively priced and compact in size.

1-12. (canceled)

13. A magnetic field generator (10; 100; 110; 120) comprising:
at least one assembly (20) of permanent anisotropic magnets (30; 31) for creating a magnetic flux and defining an air gap (40) inside which the magnetic flux is concentrated, the assembly (20) of magnets comprising:
a first element (21) and a second element (22) mounted across from each other symmetrically relative to an axis (AA) perpendicular to the transverse axis (B-B) of the air gap (40),
each of the first (21) and second (22) elements comprising at least three permanent magnets (30; 31); and
the first (21) and the second (22) element of the assembly (20) of magnets being disposed generally in a same plane and at least partially surrounded by mechanisms for closing the magnetic field (51, 52), respectively,
wherein the permanent magnets (30; 31) in the first (21) and second (22) elements of the assembly (20) of magnets comprise blocks that are parallelepipedal in shape,
the permanent magnets (30; 31) are arranged generally in a circular arc in central and first and second lateral zones, with the central zone (60) located facing the air gap (40), the first lateral zone (70) located on one side of the central zone (60) and the second lateral zone (80) located on the other side of the central zone (60),
the permanent magnets (30; 31) of the first (70) and second (80) lateral zones are magnetized in the opposite direction from an axis (A-A) which extends perpendicular to a transverse axis (B-B) of the air gap (40), and
at least two pieces of ferromagnetic material (91) and (92), which comprise a magnetic flux concentrator (90), are located on either side of the air gap (40), respectively, between the permanent magnets (30; 31) in the first lateral zones (70) of the first (21) and second (22) element of the assembly (20) of magnets, located on one side of the central zones (60) and between the permanent magnets (30) in the second lateral zones (80) of the first (21) and second (22) element of the assembly (20) of magnets, located on the other side of the central zones (60).

14. The magnetic field generator according to claim 13, wherein the permanent magnets (30, 31) comprising parallelepipedal blocks have one of a rectangular transverse cross-section (30) and a trapezoidal transverse cross-section (31).

15. The magnetic field generator according to claim 13, wherein the magnetic field generator comprises several groups of assemblies (20) of permanent anisotropic magnets (30; 31), the assemblies are identical, and the group comprises a single air gap (40), each group of magnet assemblies creates a magnetic flux and comprises a means for concentrating the magnetic flux generated by the group of assemblies (20) of magnets inside the single air gap (40).

16. The magnetic field generator (100) according to claim 13, wherein the magnetic field generator comprises several groups of assemblies (20) of permanent anisotropic magnets, the assemblies of magnets are different, juxtaposed, and designed to form a single air gap (40), each group of magnet assemblies is designed to create a magnetic flux and comprises a means for concentrating the magnetic flux generated by the groups of assemblies (20) of magnets inside the single air gap (40).

17. The magnetic field generator according to claim 13, wherein each of the mechanisms (51, 52) for closing the magnetic field of the first (21) and second (22) elements of the assembly (20) of magnets has a generally arc-shaped interior profile that corresponds to a circular arc arrangement of the central, the first lateral and the second lateral zones (60, 70, 80) of permanent magnets (30) of the first (21) and second (22) elements of the assembly (20) of magnets.

18. The magnetic field generator according to claim 17, wherein the permanent magnets (30; 31) are designed, in the assembly (20) of magnets, so that
in the central zone (60) their magnetization is approximately tangential to the adjacent surface of the mechanism (51, 52) for closing the corresponding magnetic field, and
in the first and second lateral zones (70, 80) their magnetization is perpendicular to the corresponding surface of the mechanism (51, 52) for closing the corresponding magnetic field.

19. The magnetic field generator according to claim 17, wherein in the first and the second lateral zones (70, 80) magnetization of the permanent magnets (30; 31) is perpendicular to the adjacent surface of the two pieces (91, 92) of the corresponding magnetic flux concentrator (90).

20. The magnetic field generator according to claim 17, wherein the permanent magnets (30) in the first and the second lateral zones (70, 80) are each mounted on one of the pieces (91, 92) of the corresponding magnetic flux concentrator (90).

21. The magnetic field generator according to claim 20, wherein the pieces (91, 92) of the magnetic flux concentrator (90) have oblique surfaces on one side corresponding in shape to the surface of the corresponding permanent magnets (30; 31) in the two lateral zones (70, 80) and a projecting portion (55) on the other side at the level of the air gap (40).

22. The magnetic field generator according to claim 13, wherein each first (21) element and each second (22) element of the assembly (20) of magnets is respectively associated with a first mechanism (51) and a second (52) mechanism for closing the magnetic field.

23. The magnetic field generator according to claim 13, wherein each first (21) element and each second (22) element of the assembly (20) of magnets is respectively associated with several first mechanisms (51) and second mechanisms (52) for closing the magnetic field.

24. A thermal magnetocaloric device comprising at least one magnetic field generator (10; 100; 110; 120) comprising at least one assembly (20) of permanent anisotropic magnets (30; 31) for creating a magnetic flux and defining an air gap (40) inside which the magnetic flux is concentrated, the assembly (20) of magnets comprising a first element (21) and a second element (22) mounted across from each other symmetrically relative to an axis (AA) perpendicular to the transverse axis (B-B) of the air gap (40), each of the first (21) and second (22) elements comprising at least three permanent magnets (30; 31); and the first (21) and the second (22) element of the assembly (20) of magnets being disposed generally in a same plane and at least partially surrounded by mechanisms for closing the magnetic field (51, 52), respectively, the permanent magnets (30; 31) in the first (21) and second (22) elements of the assembly (20) of magnets comprise blocks that are parallelepipedal in shape, the permanent magnets (30; 31) are arranged generally in a circular arc in central and first and second lateral zones, with the central zone (60) located facing the air gap (40), the first lateral zone (70) located on one side of the central zone (60) and the second lateral zone (80) located on the other side of the central zone (60), the permanent magnets (30; 31) of the first (70) and second (80) lateral zones are magnetized in the opposite direction from an axis (A-A) which extends perpendicular to a transverse axis (B-B) of the air gap (40), and at least two pieces of ferromagnetic material (91) and (92), which comprise a magnetic flux concentrator (90), are located on either side of the air gap (40), respectively, between the permanent magnets (30; 31) in the first lateral zones (70) of the first (21) and second (22) element of the assembly (20) of magnets, located on one side of the central zones (60) and between the permanent magnets (30) in the second lateral zones (80) of the first (21) and second (22) element of the assembly (20) of magnets, located on the other side of the central zones (60); and
one magnetocaloric element traversed by a heat-transporting fluid circulating alternately towards a first extremity of the thermal generator and towards a second extremity, as well as a means for magnetically activating and deactivating the displacement of the magnetocaloric element relative to the magnetic field generator;
wherein the magnetic field generator is designed to constitute the means for magnetically activating and deactivating the magnetic element, and in that the magnetocaloric element is located in the air gap (40) of the magnetic field generator (10; 100; 110; 120).
